(19) United States
(12) Patent Application Publication
(10) Pub. No.: US 2016/0055343 A1
(43) Pub. Date: Feb. 25, 2016

(54) HIERARCHICAL PRIVACY SETTINGS FOR COMMENTS AND MARKUPS IN A SHARED DOCUMENT

(71) Applicant: Microsoft Technology Licensing, LLC, Redmond, WA (US)

(72) Inventor: Bryan Coard, Duvall, WA (US)

(21) Appl. No.: 14/464,982

(22) Filed: Aug. 21, 2014

(51) Int. Cl. G06F 21/62; H04L 12/58; G06F 21/31

(52) U.S. Cl. CPC G06F 21/6209; G06F 21/31; H04L 51/08

(57) ABSTRACT

A user selects a markup and a privacy setting user input mechanism is displayed. User actuation of the mechanism, setting of privacy level, is received and a hierarchical privacy level of the selected markup is set. The hierarchical privacy level is stored for the selected markup.

### BACKGROUND

Computer systems are in wide use. Some such computer systems provide document management functionality and collaboration functionality to allow users to create, manage, and share documents.

In such computer systems, documents and the corresponding functionality are often hosted by a server. Users that have varying types of credentials can access the computer system in order to author, edit, review and otherwise access documents that are managed and hosted by the service.

It is not uncommon for a user to create a document and share it on the service. Other collaborative users then access the document and may provide comments or markups or other edits to the document. In order to do so, the user can synchronize the comments, markups or edits back to the server so that all collaborators can view them. Alternatively, or in addition, the user can save a local copy of the document and make his or her comments and markups there.

When the user synchronizes the comments, markups or edits back to the server, the user is often unable to make such comments, markups or, edits, etc., and keep them private. When the user makes a local copy of the document and makes the comments, markups, edits, etc. on the local copy, the user may lose any new edits to the document that are provided by others in the collaborative environment, because the user has chosen to work on a local copy.

It will be appreciated that collaborative users can provide a wide variety of inputs on a document. They can include, for instance, revisions, comments or notes, additions, other edits, etc. For purposes of this discussion, these will all be referred to as markups.

The discussion above is merely provided for general background information and is not intended to be used as an aid in determining the scope of the claimed subject matter.

### SUMMARY

A user selects a markup and a privacy setting user input mechanism is displayed. User actuation of the mechanism, setting a privacy level, is received and a hierarchical privacy level of the selected markup is set. The hierarchical privacy level is stored for the selected markup.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a document management architecture.

FIG. 2 is block diagram showing one example of a privacy component, in more detail.

FIG. 3 is a flow diagram illustrating one example of the operation of the architecture shown in FIG. 1 in allowing a user to set a privacy setting for a markup or group of markups.

FIG. 3A shows one example of a user interface display.

FIGS. 4A and 4B (collectively FIG. 4) show a flow diagram illustrating one example of the operation of the architecture shown in FIG. 1 in allowing a user to view a document with markups that have privacy levels set for them.

FIG. 5 shows one example of a user interface display.

FIG. 6 is a flow diagram illustrating one example of the operation of the architecture shown in FIG. 1 in allowing a user to share a markup.

FIG. 7 shows one example of a user interface display.

FIG. 8 is a block diagram showing one example of the architecture shown in FIG. 1, deployed in a cloud computing architecture.

FIGS. 9-10 show various embodiments of mobile devices.

FIG. 11 is a block diagram of one example of a computing environment.

### DETAILED DESCRIPTION

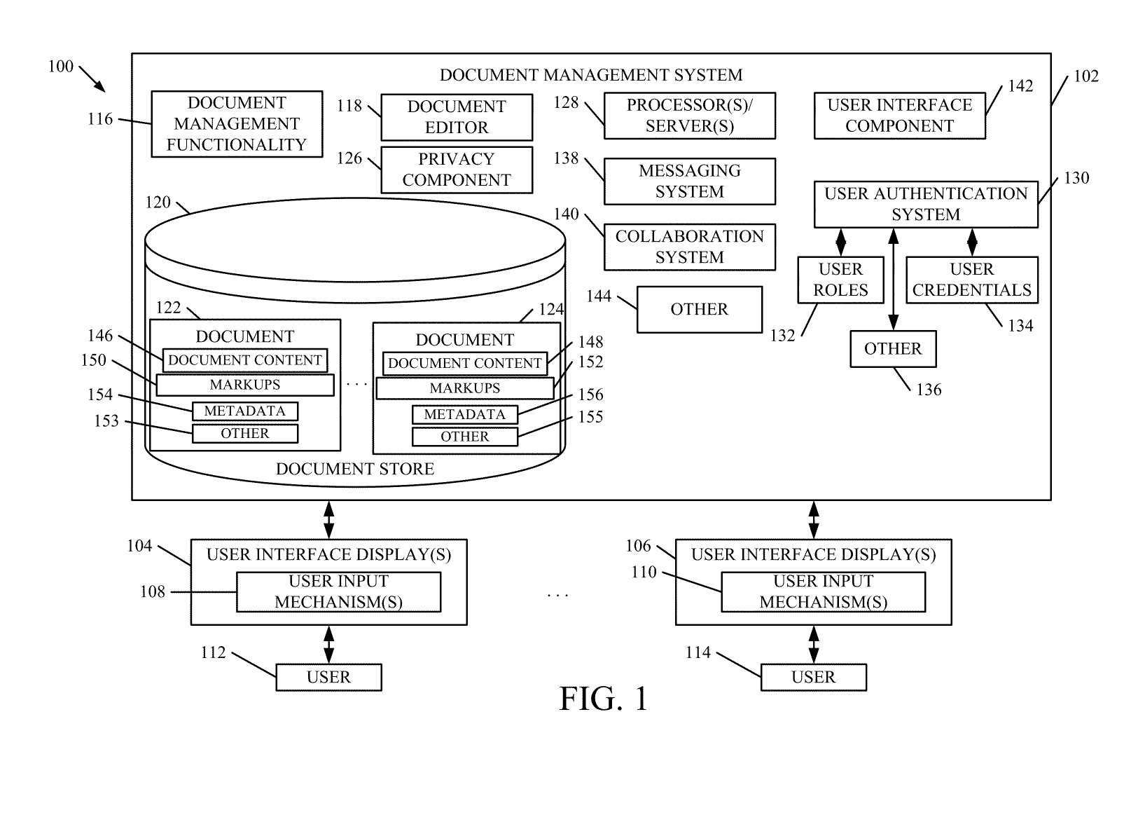

FIG. 1 is a block diagram of one example of a document management architecture 100. Architecture 100 illustratively includes document management system 102 that generates user interface displays 104-106, with user input mechanisms 108-110 for interaction by a plurality of different users 112-114. In the example shown, users 112-114 interact with user input mechanisms 108-110, respectively, in order to control and manipulate document management system 102. For instance, users 112-114 can generate or edit documents, and collaborate on the production, editing, revisions, comments, etc. relative to a given document.

Document management system 102 illustratively includes document management functionality 116, document editor 118, document store 120 (which itself, stores documents 122-124), privacy component 126, processors or servers 128, user authentication system 130 (which accesses user roles 132, user credentials 134 and other authentication information 136), messaging system 138, collaboration system 140, user interface component 142 and it can include other items 144. Before describing the operation of document management system 102 in more detail, a brief overview will be provided.

Users 112-114 illustratively access document editor 118 in order to create, edit, comment on, markup, or otherwise revise documents. The users can also use document management functionality 116 in order to perform document management tasks, such as document storage, document routing, document naming, etc. The documents 122-124 can be stored in document store 120, or elsewhere. In the example shown in FIG. 1, document store 120 is shown as part of document management system 102. It will be noted, however, that it could be remote from document management system 102, and accessed by system 102, as well.

Each document 122-124 illustratively includes document content 146-148. The document content is illustratively the text, tables, images, and other content of the document, itself. In one example, when a user (such as user 112) accesses document editor 118 and edits a document, the user can provide markups to the document. Therefore, each document 122-124 may also have a set of markups 150-152, respectively. In addition, each document may also illustratively include a set of metadata 154-156 which further defines various characteristics of the corresponding document. For instance, the metadata can include a security level assigned to the document, a security level assigned to various sets of markups, the creation date, edit history, and a wide variety of other information corresponding to the document. The documents can include other data 153-155 as well.

Collaboration system 140 illustratively provides functionality that allows multiple different users (such as users on a given team, in a given group, or a group of users otherwise associated with a document) to collaborate on the creation and editing of a given document. Therefore, collaboration system 140 illustratively provides sharing functionality so that the users can share the document in order to interactively collaborate on the document.

User interface component 142, either by itself, or under the control of another item in document management system 102, illustratively generates the user interface displays 104-106 for the various users 112-114. When a user wishes to access a document, the user illustratively provides authentication information to user authentication system 130. System 130 then illustratively compares the authentication information with user roles 132, user credentials 134, or other authentication information to determine whether the given user has permission to access the requested document. Privacy component 126 then determines whether the requested document has any sets of markups. For instance, different users 112-114 that are collaborating on a document may provide their own sets of markups to the document. If the requested document does have one or more sets of markups, then privacy component 126 determines whether those markups have a privacy level setting.

By way of example, assume that user 112 wishes to provide a set of markups or comments on a document, but that user 112 does not wish anyone else to view those comments or markups until user 112 has completely reviewed the document and finalized his or her markups. In that case, user 112 can assign a privacy level to his or her markups so that they are not viewable by any other users. In another example, it may be that the privacy level is hierarchical in nature. For instance, it may be that user 112 is a document editor, but not the document author. In that case, it may be that user 112 can only assign a privacy level which precludes everyone, except the document author, from seeing the user's markups. In such an example, the document author may always be able to see all markups that are made on the document. In another example, assume that user 112 has a user role 132 that is a team member. Assume that user 114 has a higher user role that is a team lead. Assume that another user has a lower user role of team intern. In that case, the hierarchical roles may mean that the team lead has a higher ranked role than the team member, and the team member has a higher ranked role than the team intern. In such an example, privacy component 126 may implement rules that do not permit users of a given role to preclude users of a higher role from seeing their markups. Thus, user 112 may assign a privacy level that precludes other team members from seeing the markups, and that precludes all interns from seeing the markups, but user 114 (being the team lead) may always have access to the markups. There are a wide variety of other scenarios where a hierarchical privacy level can be set with respect to a markup on of a given document. Those described above are described for the sake of example only.

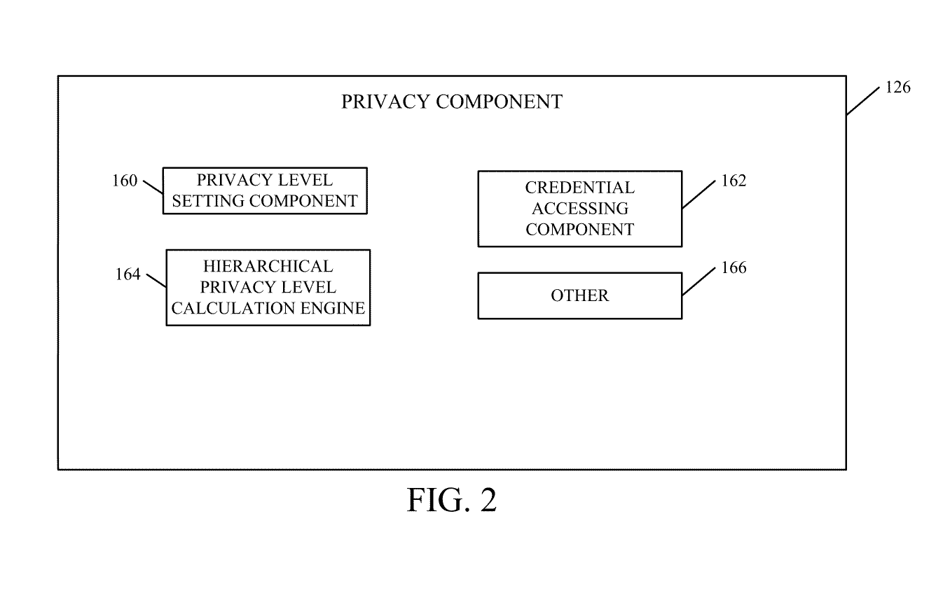

FIG. 2 shows a block diagram of one example of privacy component 126, in more detail. FIG. 2 shows that component 126 illustratively includes a privacy level setting component 160, a credential accessing component 162, a hierarchical privacy level calculation engine 164, and it can include other items 166 as well. Privacy level setting component 160 illustratively generates user interface displays with user input mechanisms that allow a user to set a privacy level for the user's markups on that document. Credential accessing component 162 then accesses the user's credentials, and may also access other hierarchical information (such as user roles 132, other user credentials 134, or other information 136) to determine where the particular user that is setting the privacy level fits in a management hierarchy (or permission hierarchy) relative to the particular document. For instance, component 162 can determine whether the user setting the privacy level is a team lead, a team member, a team intern, a department manager, etc. Hierarchical privacy level calculation engine 164 then calculates the proper privacy level setting for the set of markups. For instance, if user 112 is a team member and marks the comments private, then hierarchical privacy level calculation engine 164 will determine that everyone at the user's same hierarchical level (in the management structure or permission structure with respect to this document) and everyone lower on the hierarchical structure will be precluded from seeing the markups. However, everyone higher up in the hierarchical structure will still be allowed to see the comments. Engine 164 calculates this privacy level and assigns it to set of comments.

This can be done in a variety of different ways. For instance, the document may have an access control list which identifies people or groups that have access to the document, and which also identifies people or groups that do not have access to the document or markups in the document. In such cases, engine 164 can add the appropriate individuals to the appropriate parts of the access control list. This can be stored in metadata corresponding to the document, and it can include a markup identifier identifying the particular set of markups that this privacy level is assigned to. Of course, engine 164 can calculate the privacy level setting and assign it to the given set of markups in other ways as well.

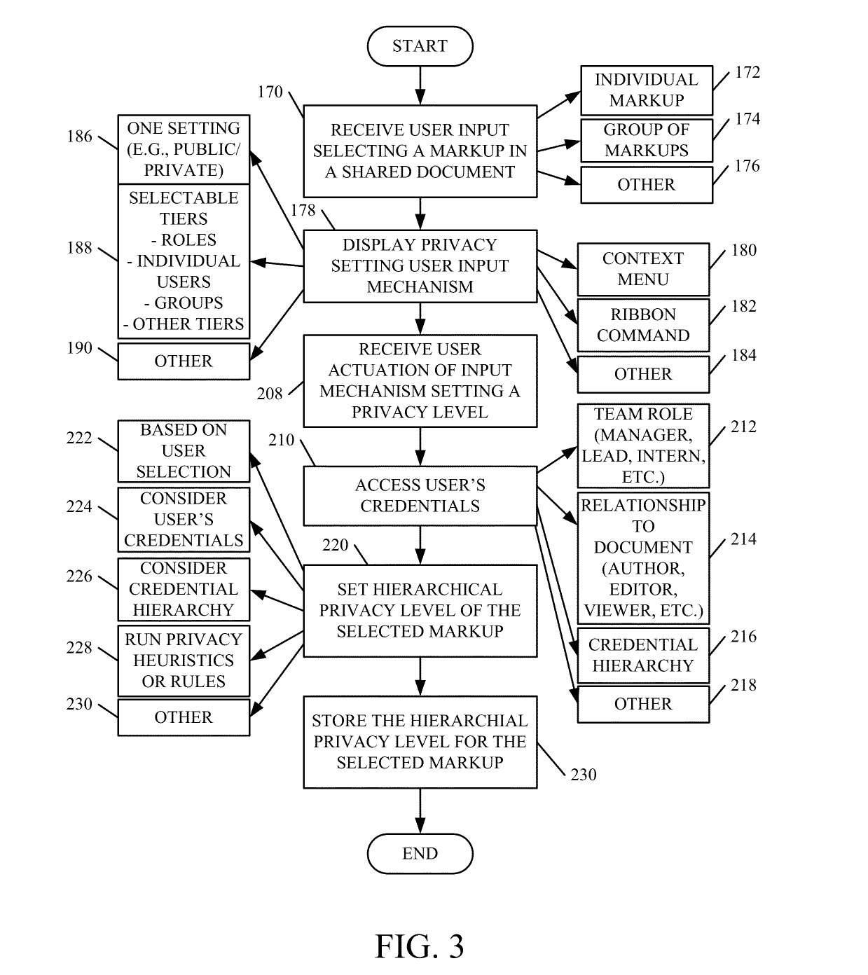

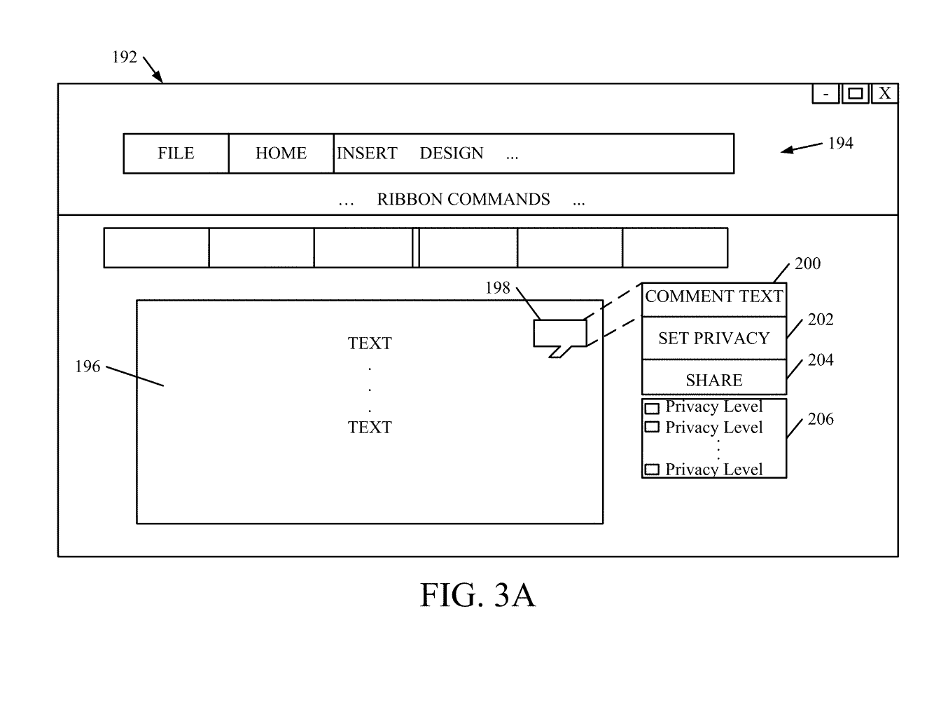

FIG. 3 is a flow diagram illustrating one example of the operation of privacy component 126 in allowing a user (such as user 112) to assign a privacy level to a set of markups. It is first assumed that user 112 has logged into system 102 and has requested access to a document (such as document 122).

It is also assumed that user 112 has appropriate permissions to view the set of markups 150 for which the user is going to be setting the privacy level. By way of example, it may be that the user 112 has just made a set of markups 150 to document 122 and it is the user's own markups for which that the user will be setting a privacy level. It may also be, however, that user 112 has access to view and reset the privacy level of a set of markups that were made by another user. In any case, it is assumed that user 112 has access to the markups and has appropriate permissions to be able to set or reset the privacy level for those markups.

Privacy level setting component 160 in privacy component 126 receives a user input selecting a markup in a shared document for which the user wishes to set a privacy level. This is indicated by block 170 in the flow diagram of FIG. 3. It may be, for instance, that user 112 selects an individual markup on document 122 for setting a privacy level. This is indicated by block 172. In another example, user 112 may select an entire set of markups for setting a privacy level so that the privacy level need not be set one markup at a time. For example, it may be that user 112 selects the set of markups that were made by user 112 or another user. Selecting a group of markups to receive a privacy level setting is indicated by block 172. User 112 can select markups in other was as well, and this is indicated by block 176.

Privacy level setting component 160 then displays a privacy setting user input mechanism so that user 112 can set the desired privacy level. This is indicated by block 178 in FIG. 3. The user input mechanism can take a wide variety of different forms. For instance, it can be a context menu 180 that is displayed when the user selects a given markup or a set of markups. It can be a ribbon command 182, or it can be another type of user input mechanism 184. In addition, the user can be allowed to set the privacy level setting in a variety of different ways as well. For instance, in one example the user can simply choose a single privacy level setting (such as switching the setting from public to private) for the selected markups. This is indicated by block 186. In another example, the user may be able to select or otherwise set the privacy level to one of a plurality of different hierarchical or tiered levels. This is indicated by block 188. By way of example, the privacy level may be selectable based upon user roles, based upon the identity of individual users, based upon groups and access levels within groups, or based upon other tiered or other hierarchical information. The user can select privacy levels in other ways as well, and this is indicated by block 190.

FIG. 3A shows one example of a user interface display 192 that indicates this. User interface display 192 is illustratively a display generated by a word processing application, that is implemented by document editor 118 in document management system 102. Thus, the display provides a control section 194 that includes a plurality of different controls. It also includes a content display portion 196 that displays textual, graphic, tabular, or other content in the document. In the example shown, the content display portion 196 includes markup indicators, such as indicator 198, that indicate that a corresponding portion of the content has a markup or comment. When the user actuates indicator 198, the markup can be displayed in display section 200. The display section 200 may illustratively include a plurality of user input mechanisms, such as a set privacy level user input mechanism 202, a share user input mechanism 204, and it can include other user input mechanisms as well.

When user 112 actuates the set privacy level user input mechanism 202, privacy level setting component 160 illustratively generates a user input mechanism 206 that allows user 112 to select or otherwise set a privacy level corresponding to the comment. Again, the settings may include a single public/private setting, or a plurality of hierarchical or tiered privacy levels that are selectable or otherwise designated by user 112. In the example shown in FIG. 3A, the particular privacy level is then assigned to the markup corresponding to indicator 198. In another example, however, a ribbon command user input mechanism in section 194 may be provided which allows the user to select different sets of markups and assign a privacy level to each selected set, as a whole. In this way, the user need not go markup-by-markup setting the privacy level for each one, unless the user wishes to do so. In yet another example, the user can set a privacy level for one entire group of markups, but then go to individual markups within that group and set a different privacy level for those individual markups. All of these architectures are contemplated herein.

Returning again to the flow diagram of FIG. 3, receiving user actuation of an input mechanism, setting the privacy level, is indicated by block 208.

Once the user has set a privacy level to be assigned to a markup or a group of markups, then credential accessing component 162 accesses the user's credentials to see the level of authority that the user has to set the privacy level. Accessing the user's credentials is indicated by block 210 in FIG. 3. This can include accessing the user's team role relative to a team that corresponds to the document being accessed. The team role is indicated by block 212, and it may include manager, lead, intern, or a wide variety of other hierarchical roles. Component 162 can also access information that indicates the user's relationship to the document. This is indicated by block 214, and it can include such things as the document author, editor, viewer, etc. Credential accessing component 162 also accesses a credential or other hierarchy 216 to determine a set of other users that may be higher up in the management or permission hierarchy. Component 162 can access other information 218 as well.

Once the relevant credential, authentication, role, or other privacy information is accessed, it is provided to hierarchical privacy level calculation engine 164 which sets the hierarchical privacy level of the selected markup (or group of markups). This is indicated by block 220. In doing so, engine 164 illustratively receives the user's privacy level selection. This is indicated by block 222. It can also consider the user's credentials, role, relationship to the document, etc., as indicated by block 224. Engine 164 also illustratively considers the credential hierarchy (or management or permission hierarchy) and the location where the present user fits in that hierarchy. This is indicated by block 226. Engine 164 can then run privacy heuristics or rules or access a privacy level mapping, or use other mechanisms to calculate the appropriate privacy level for the selected markup (or group of markups). This is indicated by block 228. Engine 164 can perform other operations 230 to identify an appropriate privacy level as well.

Once engine 164 calculates the appropriate privacy level for the markup (or group of markups), it stores the hierarchical privacy level for the selected markup (or group of markups). This is indicated by block 230 in FIG. 3. Again, this can be done in a variety of different ways as well. For instance, it can make appropriate entries on the access control list corresponding to the document and indicate that those entries are for the selected markup (or group of markups). It can tag the selected markup (or group of markups) in other ways and indicate that they have the corresponding privacy level. A wide variety of other ways of marking the appropriate markups with the calculated privacy level can also be used.

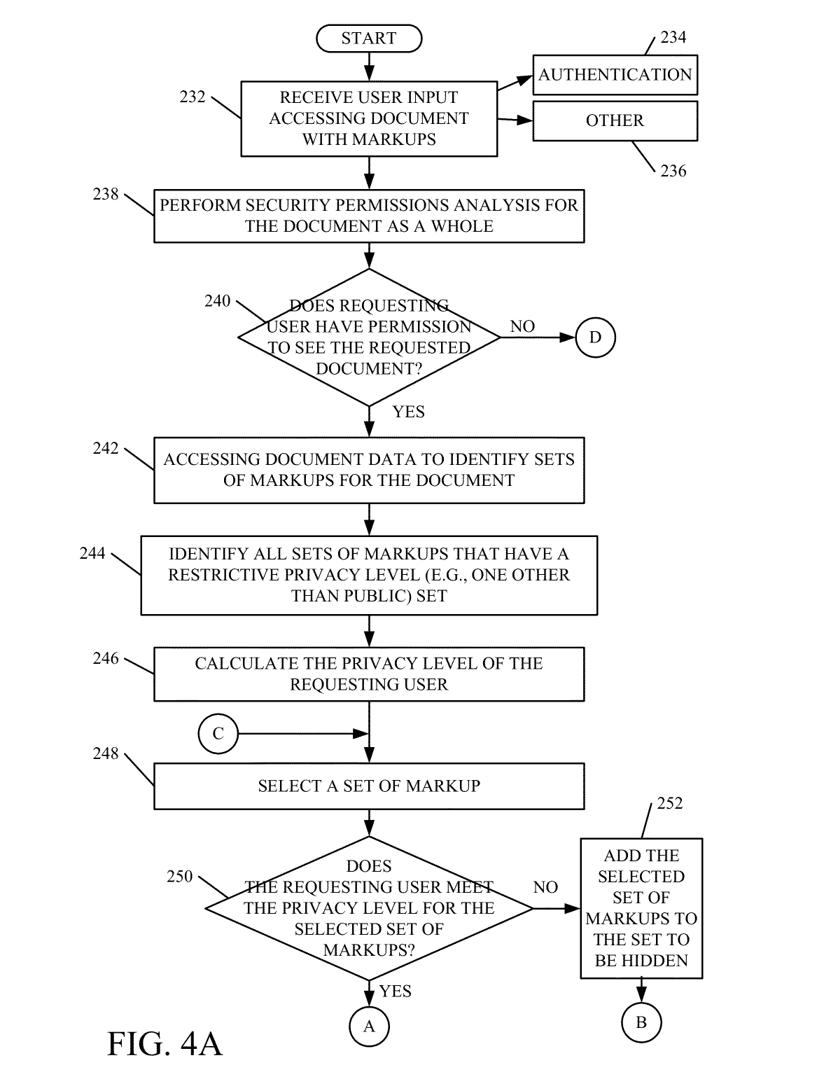

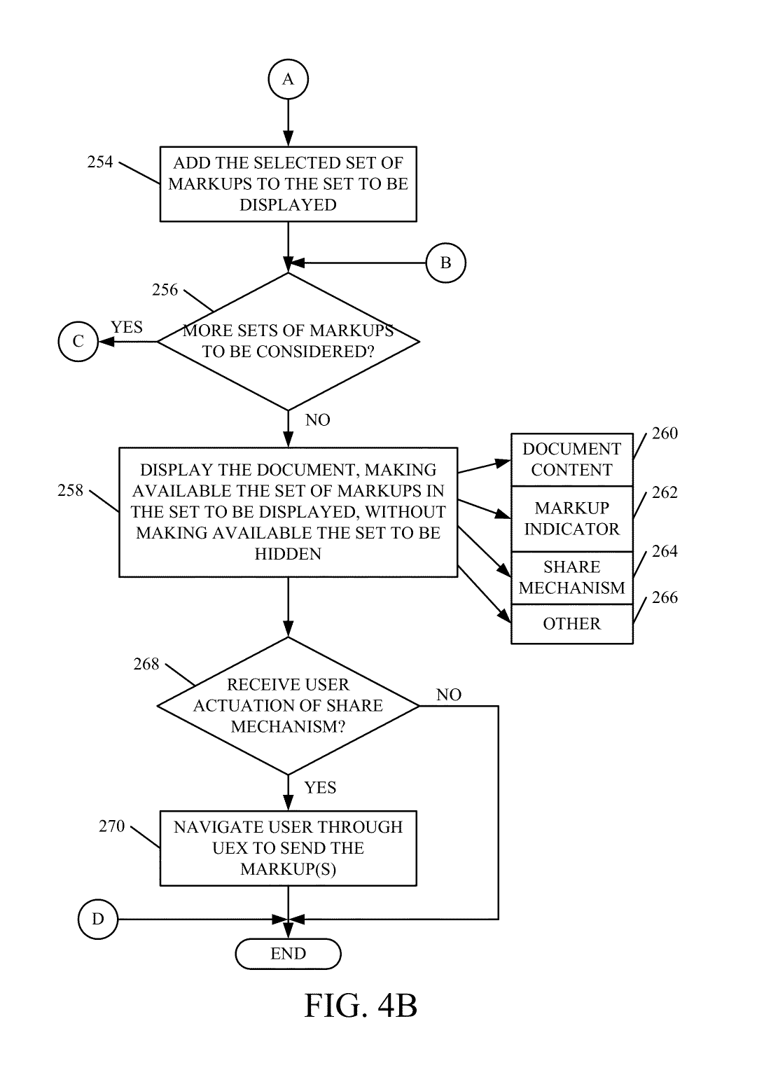

FIGS. 4A and 4B (collectively FIG. 4) illustrate one example of the operation of document management system 102 (and specifically privacy component 126) in allowing different users to access different documents and sets of markups that have associated privacy level settings. System 102 first receives a user input from a user indicating that the user wishes to access a document (such as document 122) that includes markups 150. This is indicated by block 232 in the flow diagram of FIG. 4. In doing so, the user can illustratively provide authentication information 234 or other information 236.

User authentication system 130 then performs security permissions analysis for the requesting user and the requested document, as a whole. This is indicated by block 238. Authentication system 130 determines whether the requesting user has appropriate permissions to view the document, at all. Determining whether the requesting user has permission to view the document at all is indicated by block 240. If not, processing is completed. If so, however, then privacy component 126 accesses the data corresponding to the requested document to identify whether it includes any sets of markups. This is indicated by block 242.

For instance, if there are no markups on the requested document, and the user has permissions to view the document, then the document is simply displayed to the user. However, if there are markups on the document, then privacy component 126 identifies all of the different sets of markups that have a restrictive privacy level (e.g., a privacy level that purports to restrict any users from viewing those markups). This is indicated by block 244 in FIG. 4. Privacy component 126 then calculates the privacy level of the requesting user, based upon the user's credentials or role or other authentication information provided by the user. This is indicated by block 246 in FIG. 4.

Privacy component 126 then selects a set of markups that has a privacy level set and determines whether the requesting user meets the privacy level for the selected set of markups. This is indicated by blocks 248 and 250 in FIG. 4. If the requesting user does not have credentials that meet the privacy level set for this set of markups, then this set of markups is added to the set of markups for this document that are to be hidden from this user. This is indicated by block 252. If, however, the requesting user does meet the privacy level for the selected set of markups, then the selected set of markups is added to the set of markups that are to be made available to the user along with the document. This is indicated by block 254 in FIG. 4.

Privacy component 126 then determines whether there are any more sets of markups for the requested document. This is indicated by block 256. If so, processing reverts to block 248 where privacy component 126 selects a next set of comments and determines whether the user should be able to see these comments or whether they should be hidden. This continues until all sets of markups that have a privacy level set for them have been considered.

Processing then continues at block 258 where system 102 displays the document for the requesting user, and makes available to the requesting user all of the sets of markups that are to be displayed, but does not make available the markups that are to be hidden. This can be done in a wide variety of different ways. For instance, system 102 can display the document content as indicated by block 260. It can also display markup indicators to indicate where markups have been made in the collaborative environment. It can also display a share mechanism corresponding to each markup or group of markups, as indicated by block 264. Other items can be displayed as well, as indicated by block 266.

Thus, it can be seen that the system allows a user who has appropriate permissions or authority, to set a privacy level corresponding to individual markups or groups of markups, or a combination of individuals and groups. The system automatically calculates different hierarchical privacy levels to determine which users may have access to the markups based upon the user settings. This makes the document management system 102 perform much more efficiently. Instead of having a user save a local copy of a document and provide markups on the local copy, and then upload only those markups that the user wishes to publish to the rest of the collaborative environment, the system allows the user to work from the collaborative document, but still control dissemination of the user's markups. This makes it much more likely that the user's version of the document will remain synchronized with the collaborative version of the document, even while the user is editing, marking, commenting on, or otherwise revising the document.

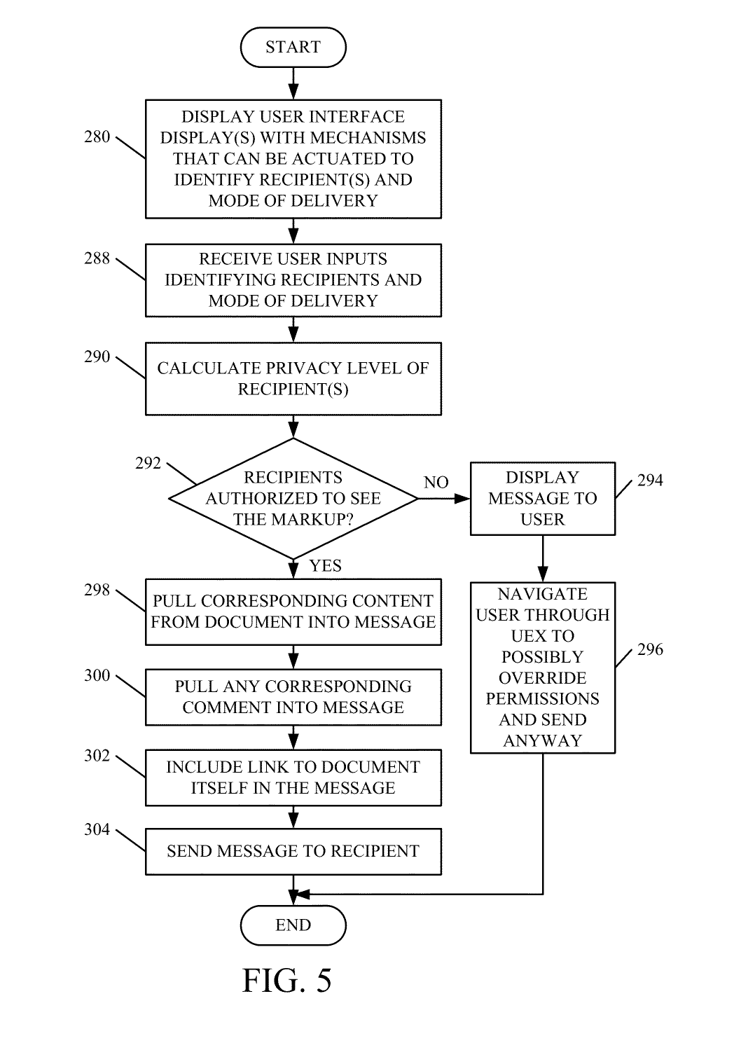

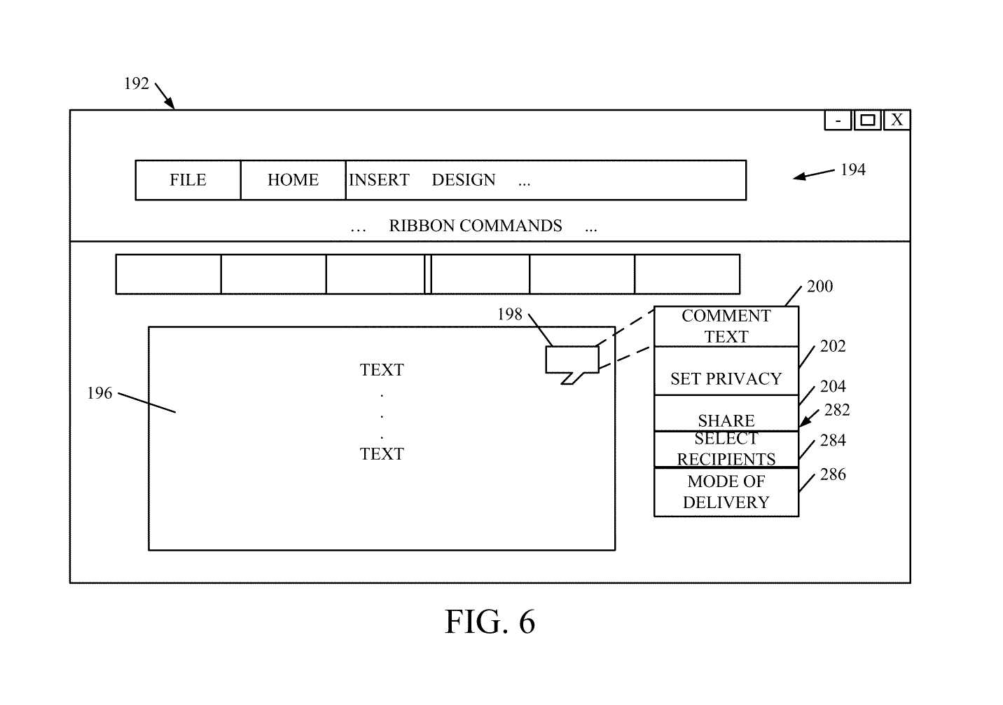

In another example, it may be that a user who is viewing a markup, or a set of markups, may wish to immediately share an individual markup or a group of markups with another user, but not with an entire group. In that case, the user can illustratively actuate the share mechanism (such as user input mechanism 204 shown in FIG. 3A) to share a corresponding markup or set of markups, with another user or with a selected group of users. Receiving user actuation of the share mechanism is indicated by block 268 in FIG. 4. In response, messaging system 138 (in document management system 102) illustratively navigates the user through a user experience that allows the user to send the markups to desired users or groups of users. This is indicated by block 270, and it is described in greater detail below with respect to FIGS. 5 and 6.

FIG. 5 is a flow diagram illustrating one example of the operation of system 102 in providing user input mechanisms that allow a user to share an individual markup, or a group of markups with a designated user or a designated set of users. FIG. 6 is one example of a user interface display that indicates this. FIGS. 5 and 6 will now be described in conjunction with one another.

It is first assumed that the user (such as user 112) has accessed a document (such as document 122) and is viewing or has otherwise selected a single markup or a group of markups 150 on the selected document 122. It is further assumed that the user has actuated the share user input mechanism 204 corresponding to an individual markup 200 or to a group of markups. In that case, messaging system 138 illustratively displays a user interface display with a user input mechanism that can be actuated to identify recipients and a mode of delivery. This is indicated by block 280 in FIG. 5. By way of example, FIG. 6 shows the user interface display 192 that was shown in FIG. 3A, and similar items are similarly numbered. However, in FIG. 6, the user has now actuated the share actuator user input mechanism 204. Thus, messaging system 138 illustratively displays a user input mechanism 282 that includes a recipient selector 284 and a mode of delivery selector 286. When the user actuates selector 284, the user is illustratively navigated to a member list that identifies various members associated with the displayed document. The user can be navigated to other lists, such as contact lists, distribution lists, management lists, or a wide variety of other lists of users as well. Through the appropriate user interface displays, user 112 illustratively selects one or more recipients for the identified markup 200 (or for a group or set of markups).

User 112 can also actuate selector 286 to select a mode of delivery. By way of example, the user may select that the markup be delivered by text message, by e-mail, or by other delivery methods. Receiving user inputs identifying recipients and a mode of delivery is indicated by block 288 in the flow diagram of FIG. 5.

Privacy component 126 then calculates the privacy level of the recipients of the selected markup as indicated by block 290. It then determines whether the recipients are authorized to see the markup. This is indicated by block 292. If not, then it illustratively displays a message to the user indicating this, as indicated by block 294, and it can navigate the user through a user experience to possibly override the permissions and send the markup anyway, assuming that user 112 has adequate authority or permissions or authentication level to do so. This is indicated by block 296.

However, if, at block 292, it is determined that the recipients are authorized to see the markup, then messaging system 138 illustratively pulls corresponding content from the content portion of the document 122 into the message. This is indicated by block 298 in FIG. 5. By way of example, assume that the selected markup corresponds to a highlighted portion of the text or other content in the document. In one example, messaging system 138 not only pulls the entire content of the markup, itself, but it also pulls the corresponding portion of the content of the document.

Further, messaging system 138 can also pull the corresponding markup into the message as indicated by block 300. Messaging system 138 also illustratively includes a link, in the message, to the document itself. This is indicated by block 302. Therefore, if the recipient wishes to see the entire document that the markup relates to, the recipient can illustratively actuate the link and access the document directly from the received message. Messaging system 138 then sends the message to the identified recipient or recipients.

Thus, it can be seen that the system not only allows a user to select individual or groups of markups and assign them privacy levels, but it also allows the user to quickly and easily share markups from a document with other recipients. A user can thus quickly mark a group of his or her markups (or other markups that he or she has access to) with a corresponding security level, but still send individual markups or groups of markups to other recipients as desired. This enhances the performance of the document management system itself, in that it makes it much more efficient in the processing and handling of markups to documents in the collaborative environment.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

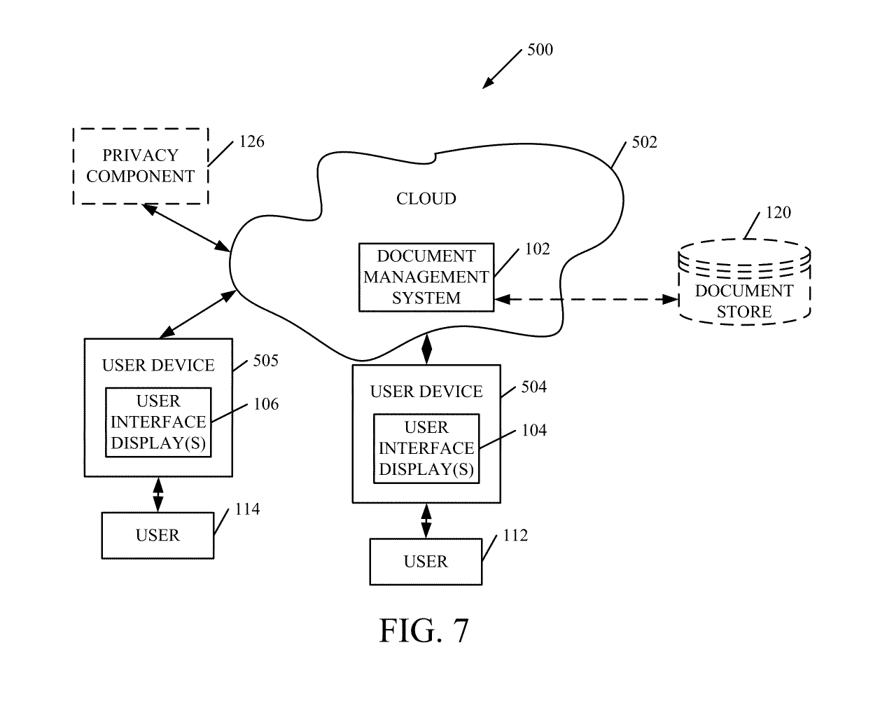

FIG. 7 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 7, some items are similar to those shown in FIG. 1 and they are similarly numbered. FIG. 7 specifically shows that system 102 can be located in cloud 502 (which can be public, private, or a combination where portions are public while others are private). Therefore, users 112 and 114 use a user devices 504 and 505 to access those systems through cloud 502.

FIG. 7 also depicts another example of a cloud architecture. FIG. 7 shows that it is also contemplated that some elements of system 102 can be disposed in cloud 502 while others are not. By way of example, data store 120 can be disposed outside of cloud 502, and accessed through cloud 502. In another embodiment, privacy component 126 can also be outside of cloud 502. Regardless of where they are located, they can be accessed directly by devices 504 and 505, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

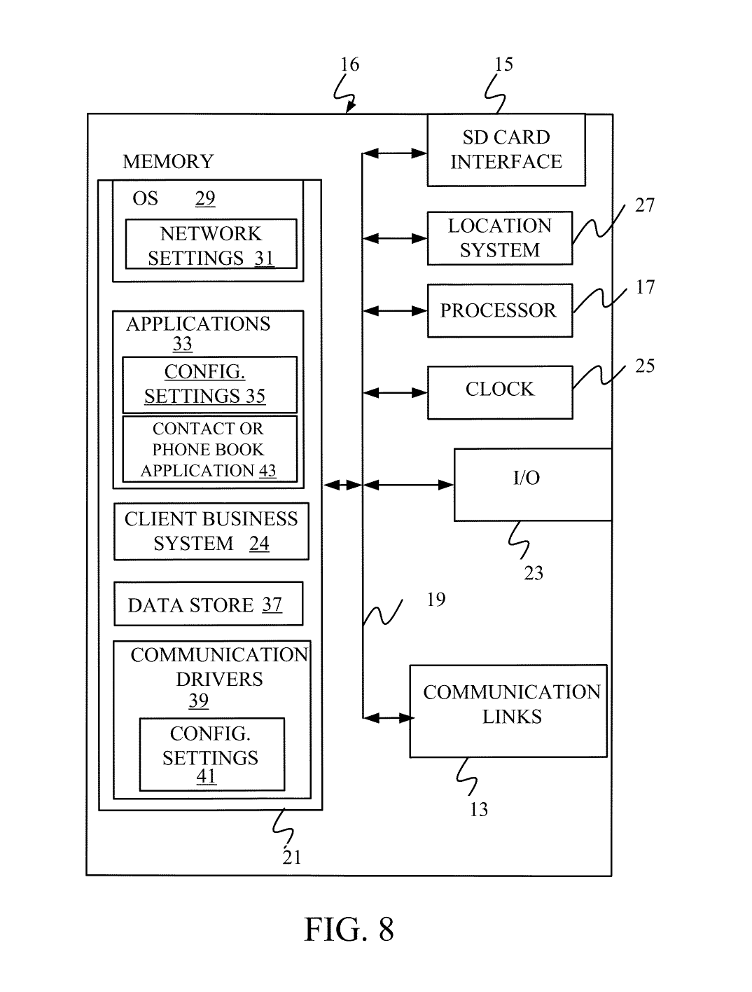

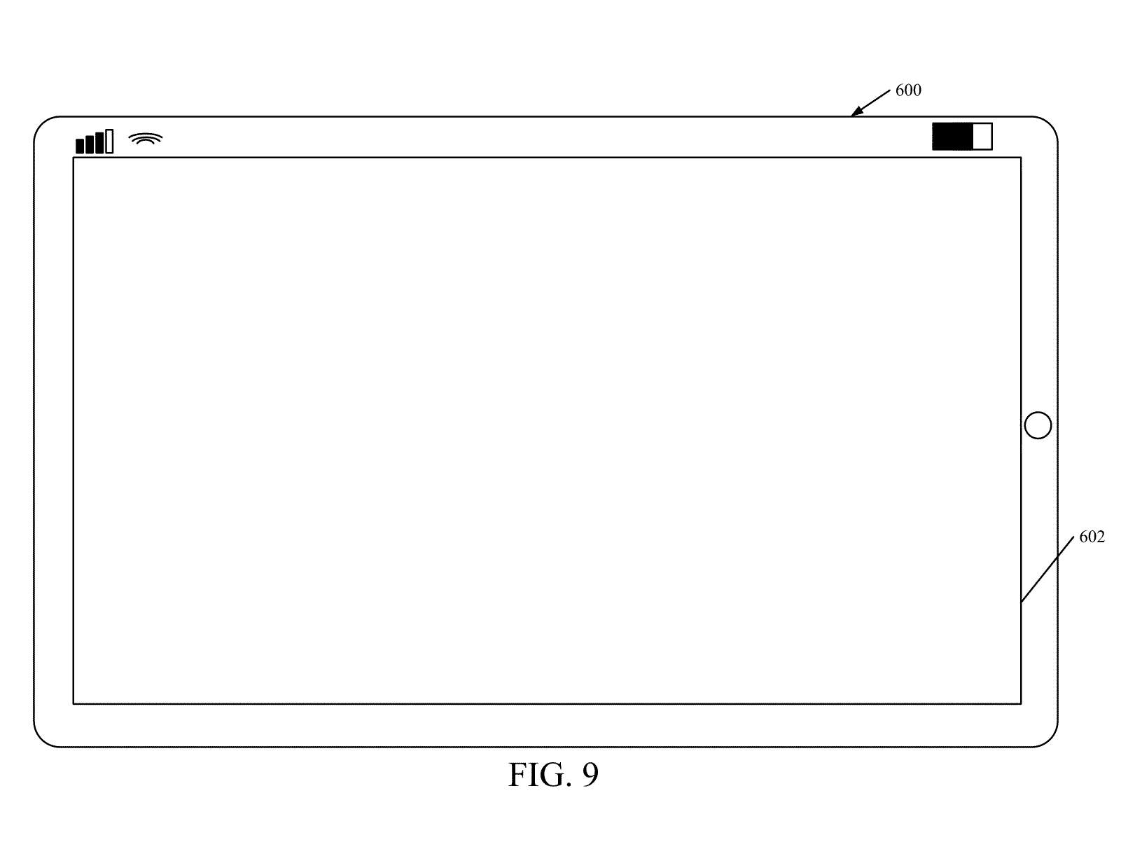

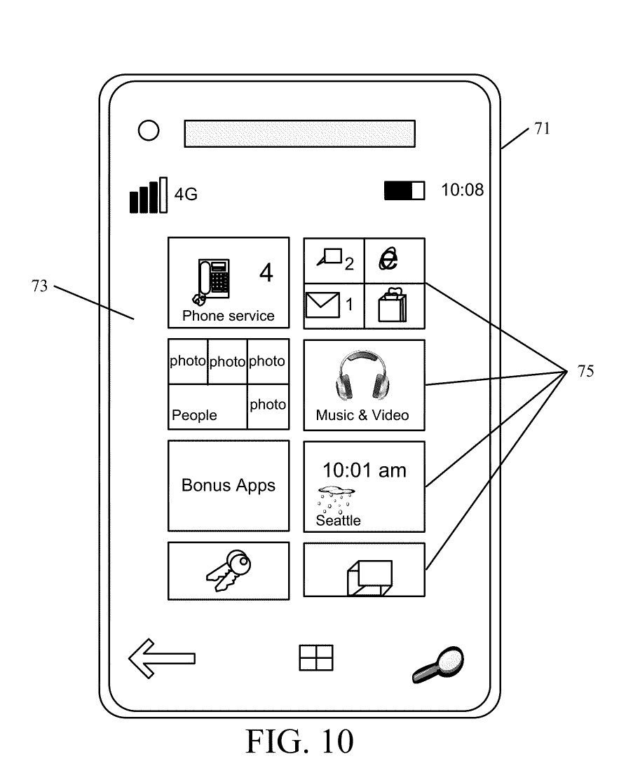

FIG. 8 is a simplified block diagram of one illustrative embodiment of a handheld or mobile computing device that can be used as a user's or client's hand held device 16, in which the present system (or parts of it) can be deployed. FIGS. 9-10 are examples of handheld or mobile devices.

FIG. 8 provides a general block diagram of the components of a client device 16 that can run components of architecture 100 or that interacts with architecture 100, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processor/servers 128 from FIG. 1 or those in devices 504 and 505) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client business system 24 which can run various business applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 9 shows one embodiment in which device 16 is a tablet computer 600. In FIG. 9, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 can be used as well. For instance, device 16 can be a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1Xrtt, and Short Message Service (SMS) signals. In some embodiments, the phone also includes a Secure Digital (SD) card slot that accepts a SD card.

The mobile device can also be a personal digital assistant (PDA) or a multimedia player or a tablet computing device, etc. (hereinafter referred to as PDA). The PDA can include an inductive screen that senses the position of a stylus (or other pointers, such as a user's finger) when the stylus is positioned over the screen. This allows the user to select, highlight, and move items on the screen as well as draw and write. The PDA also includes a number of user input keys or buttons which allow the user to scroll through menu options or other display options which are displayed on the display, and allow the user to change applications or select user input functions, without contacting the display. The PDA can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

FIG. 10 shows that the phone can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

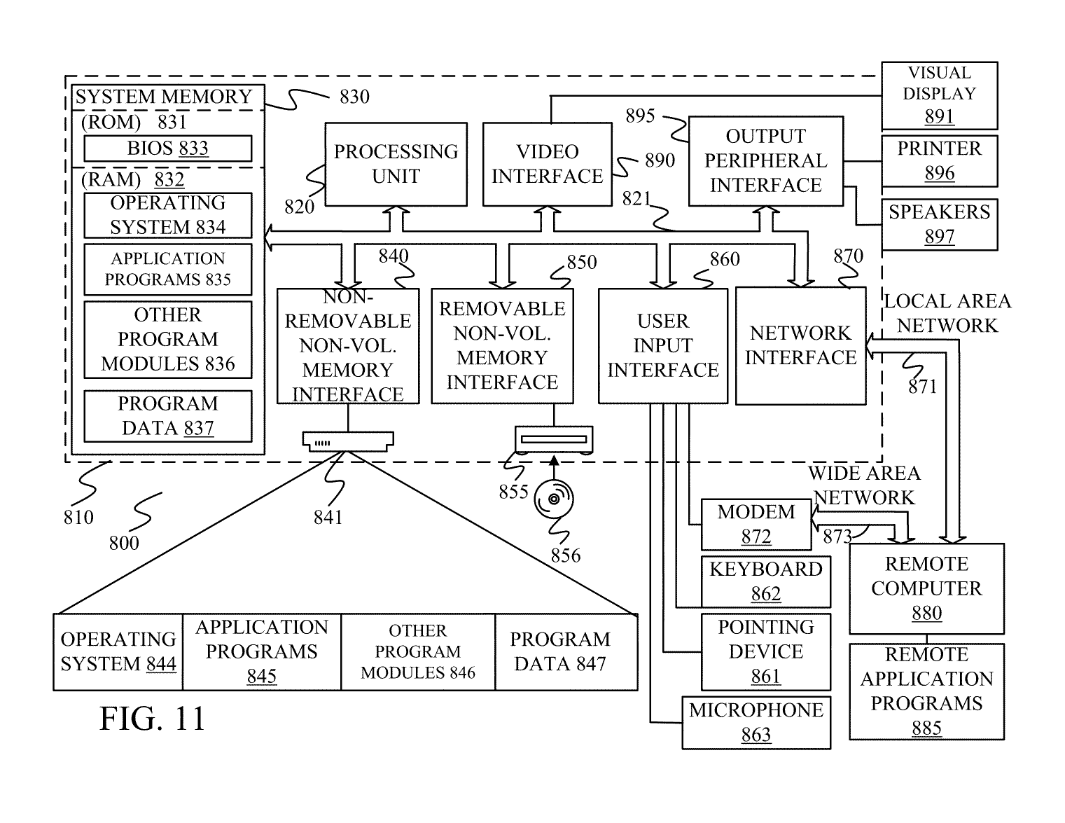

FIG. 11 is one embodiment of a computing environment in which architecture 100, or parts of it, (for example) can be deployed. With reference to FIG. 11, an exemplary system for implementing some embodiments includes a general-purpose computing device in the form of a computer 810. Components of computer 810 may include, but are not limited to, a processing unit 820 (which can comprise processor/server 128 or those in devices 504 and 505), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 11 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 11 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a document management system, comprising:

a collaboration system that provides collaboration user input mechanisms that are actuated to perform collaboration functions on a shared document; and

a privacy component that displays a privacy setting user input mechanism that is actuated to set a restrictive privacy level, of a plurality of settable restrictive privacy levels, for a markup corresponding to the shared document.

Example 2 is the document management system of any or all previous examples wherein the privacy component comprises:

a privacy level setting component that receives a markup input indicative of user selection of the markup.

Example 3 is the document management system of any or all previous examples wherein the privacy component comprises:

a hierarchical privacy level calculation engine that receives a privacy level indication, indicative of the restrictive privacy level set for the selected markup, and calculates a calculated privacy level for the selected markup and assigns the calculated privacy level to the selected markup.

Example 4 is the document management system of any or all previous examples wherein the privacy component comprises:

a credential accessing component that accesses hierarchical information corresponding to the user setting the restrictive privacy level for the selected markup, the hierarchical privacy level calculation engine calculating the calculated privacy level based on the hierarchical information accessed.

Example 5 is the document management system of any or all previous examples wherein the credential accessing component accesses hierarchical information corresponding to users related to the shared document that has the corresponding selected markup, the hierarchical privacy level calculation engine calculating the calculated privacy level based on the hierarchical information accessed.

Example 6 is the document management system of any or all previous examples wherein the hierarchical information corresponding to the user comprises one of a user role for the user, the user's relationship to the shared document, and a location where the user resides in a credential hierarchy.

Example 7 is the document management system of any or all previous examples wherein the hierarchical information corresponding to the users related to the shared document comprises a role of each of the users, each user's relationship to the shared document, and a location where each of the users reside in a credential hierarchy.

Example 8 is the document management system of any or all previous examples wherein the privacy component displays the privacy setting user input mechanism that is actuated to set the restrictive privacy level for a group of markups corresponding to the shared document.

Example 9 is the document management system of any or all previous examples and further comprising:

a messaging system, the privacy component generating a share user input mechanism corresponding to the selected markup, the share user input mechanism being actuated to identify a recipient and mode of delivery for the selected markup, the privacy component calculating whether the recipient has credentials that meet the restrictive privacy level set for the selected markup, the messaging system sending the selected markup to the recipient if the recipient has credentials that meet the restrictive privacy level set for the selected markup.

Example 10 is the document management system of any or all previous examples wherein, in response to actuation of the privacy component calculating that the recipient has credentials that meet the restrictive privacy level, the messaging system generates a message that includes markup content of the selected markup, corresponding content of the shared document and a link to the shared document and sends the message to the recipient.

Example 11 is a document management system, comprising:

a collaboration system that generates document accessing user input mechanisms that are actuated to access a shared document with corresponding markups that have a restrictive privacy level set;

a privacy component that accesses credential data corresponding to the requesting user and that identifies, as displayable markups, any markups for which a requesting user has credentials that meet the restrictive privacy level, and that identifies, as hidden markups, any markups for which a requesting user does not have credentials that meet the restrictive privacy level; and

a user interface component that displays the shared document, making the displayable markups accessible to the requesting user, without making the hidden markups accessible to the requesting user.

Example 12 is the document management system of any or all previous examples wherein the privacy component comprises:

a privacy level setting component that generates a privacy level setting user input mechanism that is actuated to set the restrictive privacy level, for a corresponding markup, to one of a plurality of tiered privacy levels.

Example 13 is the document management system of any or all previous examples wherein the privacy level setting user input mechanism is actuated to set the restrictive privacy level to one of the plurality of tiered privacy levels that are tiered based on user credentials.

Example 14 is the document management system of any or all previous examples wherein the user credentials that are used to tier the plurality of tiered privacy levels comprise user roles in the document management system.

Example 15 is the document management system of any or all previous examples wherein the user credentials that are used to tier the plurality of tiered privacy levels comprise user relationships to the shared document in the document management system.

Example 16 is the document management system of any or all previous examples wherein the collaboration system displays a share user input mechanism, corresponding to a given markup, that is actuated to identify a recipient of a message based on the given markup, and further comprising:

a privacy level calculation component that accesses credential information for the recipient to determine whether the recipient has credentials that meet the restrictive privacy level.

Example 17 is the document management system of any or all previous examples and further comprising:

a messaging system that, in response to the privacy level calculation component determining that the recipient meets the restrictive privacy level of the given markup, generates a message including content of the given markup, content of the shared document that relates to the given markup, and a link to the shared document and sends the message to the recipient.

Example 18 is a method, comprising:

receiving a user input accessing a given markup on a shared document;

displaying a privacy level setting input mechanism for the given markup;

receiving actuation of the privacy level setting input mechanism, identifying a restrictive privacy level, of a plurality of selectable restrictive privacy levels;

associating the identified restrictive privacy level with the given markup; and

restricting subsequent access to the given markup based on the identified restrictive privacy level.

Example 19 is the method of any or all previous examples wherein restricting subsequent access comprises:

receiving a subsequent user input accessing the given markup; and

calculating whether a user associated with the subsequent user input has a privacy level that meets the restrictive privacy level associated with the given markup; and

providing the user with access to the given markup based on the calculation.

Example 20 is the method of any or all previous examples wherein the plurality of selectable restrictive privacy levels comprise tiered privacy levels based on user roles and wherein calculating comprises:

accessing a user role for the user and calculating the privacy level for the user based on the accessed user role.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A document management system, comprising:
a collaboration system that provides collaboration user input mechanisms that are actuated to perform collaboration functions on a shared document; and
a privacy component that displays a privacy setting user input mechanism that is actuated to set a restrictive privacy level, of a plurality of settable restrictive privacy levels, for a markup corresponding to the shared document.

2. The document management system of claim 1 wherein the privacy component comprises:
a privacy level setting component that receives a markup input indicative of user selection of the markup.

3. The document management system of claim 2 wherein the privacy component comprises:
a hierarchical privacy level calculation engine that receives a privacy level indication, indicative of the restrictive privacy level set for the selected markup, and calculates a calculated privacy level for the selected markup and assigns the calculated privacy level to the selected markup.

4. The document management system of claim 3 wherein the privacy component comprises:
a credential accessing component that accesses hierarchical information corresponding to the user setting the restrictive privacy level for the selected markup, the hierarchical privacy level calculation engine calculating the calculated privacy level based on the hierarchical information accessed.

5. The document management system of claim 4 wherein the credential accessing component accesses hierarchical information corresponding to users related to the shared document that has the corresponding selected markup, the hierarchical privacy level calculation engine calculating the calculated privacy level based on the hierarchical information accessed.

6. The document management system of claim 5 wherein the hierarchical information corresponding to the user comprises one of a user role for the user, the user's relationship to the shared document, and a location where the user resides in a credential hierarchy.

7. The document management system of claim 6 wherein the hierarchical information corresponding to the users related to the shared document comprises a role of each of the users, each user's relationship to the shared document, and a location where each of the users reside in a credential hierarchy.

8. The document management system of claim 3 wherein the privacy component displays the privacy setting user input mechanism that is actuated to set the restrictive privacy level for a group of markups corresponding to the shared document.

9. The document management system of claim 3 and further comprising:
a messaging system, the privacy component generating a share user input mechanism corresponding to the selected markup, the share user input mechanism being actuated to identify a recipient and mode of delivery for the selected markup, the privacy component calculating whether the recipient has credentials that meet the restrictive privacy level set for the selected markup, the messaging system sending the selected markup to the recipient if the recipient has credentials that meet the restrictive privacy level set for the selected markup.

10. The document management system of claim 10 wherein, in response to actuation of the privacy component calculating that the recipient has credentials that meet the restrictive privacy level, the messaging system generates a message that includes markup content of the selected markup, corresponding content of the shared document and a link to the shared document and sends the message to the recipient.

11. A document management system, comprising:
a collaboration system that generates document accessing user input mechanisms that are actuated to access a shared document with corresponding markups that have a restrictive privacy level set;
a privacy component that accesses credential data corresponding to the requesting user and that identifies, as displayable markups, any markups for which a requesting user has credentials that meet the restrictive privacy level, and that identifies, as hidden markups, any markups for which a requesting user does not have credentials that meet the restrictive privacy level; and
a user interface component that displays the shared document, making the displayable markups accessible to the requesting user, without making the hidden markups accessible to the requesting user.

12. The document management system of claim 11 wherein the privacy component comprises:
a privacy level setting component that generates a privacy level setting user input mechanism that is actuated to set the restrictive privacy level, for a corresponding markup, to one of a plurality of tiered privacy levels.

13. The document management system of claim 12 wherein the privacy level setting user input mechanism is actuated to set the restrictive privacy level to one of the plurality of tiered privacy levels that are tiered based on user credentials.

14. The document management system of claim 13 wherein the user credentials that are used to tier the plurality of tiered privacy levels comprise user roles in the document management system.

15. The document management system of claim 13 wherein the user credentials that are used to tier the plurality of tiered privacy levels comprise user relationships to the shared document in the document management system.

16. The document management system of claim 13 wherein the collaboration system displays a share user input mechanism, corresponding to a given markup, that is actuated to identify a recipient of a message based on the given markup, and further comprising:
a privacy level calculation component that accesses credential information for the recipient to determine whether the recipient has credentials that meet the restrictive privacy level.

17. The document management system of claim 16 and further comprising:
a messaging system that, in response to the privacy level calculation component determining that the recipient meets the restrictive privacy level of the given markup, generates a message including content of the given markup, content of the shared document that relates to the given markup, and a link to the shared document and sends the message to the recipient.

18. A method, comprising:
receiving a user input accessing a given markup on a shared document;
displaying a privacy level setting input mechanism for the given markup;
receiving actuation of the privacy level setting input mechanism,
identifying a restrictive privacy level, of a plurality of selectable restrictive privacy levels;
associating the identified restrictive privacy level with the given markup; and
restricting subsequent access to the given markup based on the identified restrictive privacy level.

19. The method of claim 18 wherein restricting subsequent access comprises:
receiving a subsequent user input accessing the given markup; and
calculating whether a user associated with the subsequent user input has a privacy level that meets the restrictive privacy level associated with the given markup; and
providing the user with access to the given markup based on the calculation.

20. The method of claim 19 wherein the plurality of selectable restrictive privacy levels comprise tiered privacy levels based on user roles and wherein calculating comprises:
accessing a user role for the user and calculating the privacy level for the user based on the accessed user role.
